(19) United States
(12) Patent Application Publication
(10) Pub. No.: US 2015/0370481 A1
(43) Pub. Date: Dec. 24, 2015

(54) SEMICONDUCTOR DEVICE

(71) Applicant: SK Hynix Inc., Icheon-si Gyeonggi-do (KR)

(72) Inventor: Jung Ryul AHN, Icheon-si Gyeonggi-do (KR)

(21) Appl. No.: 14/558,377

(22) Filed: Dec. 2, 2014

(30) Foreign Application Priority Data
Jun. 23, 2014 (KR) 10-2014-0076439

(51) Int. Cl. G06F 3/06

(52) U.S. Cl. CPC G06F 3/0604; G06F 3/0659; G06F 3/0679

(57) ABSTRACT

A semiconductor device may include a memory block including a plurality of memory cells, and an operation circuit configured to perform a first program loop, a second program loop, and a third program loop based on data stored in the memory cells. The first program loop may distribute threshold voltages of the memory cells into four levels. The second program loop may distribute the threshold voltages of the memory cells into seven levels. The third program loop may distribute the threshold voltages of the memory cells into eight levels.

### CROSS-REFERENCE TO RELATED APPLICATION

The present application claims priority to Korean patent application number 10-2014-0076439 filed on Jun. 23, 2014, in the Korean Intellectual Property Office, the entire disclosure of which is incorporated by reference herein.

### BACKGROUND

1. Technical Field

Various embodiments generally relate to a semiconductor device. More specifically, the various embodiments relate to a semiconductor device capable of storing data.

2. Related Art

In a flash memory device, a threshold voltage of a memory cell is changed based on stored data. When one bit data is stored in a unit memory cell, the threshold voltages of the memory cells are distributed into an erase level and a program level. When two bit data is stored in the unit memory cell, the threshold voltages of the memory cells are distributed into the erase level and three different program levels. When three bit data is stored in the unit memory cell, the threshold voltages of the memory cells are distributed into the erase level and seven different program levels.

In order to store the data in the memory cell, a program loop including a program operation and a program verify operation is repeated by an Increment Step Pulse Program (ISPP) method. A program voltage is increased at every program loop until the data is normally stored in the memory cell.

When the number of the bits in the data stored in the unit memory cell is increased, an efficient method for storing data is required.

### BRIEF SUMMARY

In an embodiment, a semiconductor device is provided. The semiconductor device may include a memory block including a plurality of memory cells, and an operation circuit configured to perform a first program loop, a second program loop, and a third program loop based on data stored in the memory cells. The first program loop may distribute threshold voltages of the memory cells into four levels. The second program loop may distribute the threshold voltages of the memory cells into seven levels. The third program loop may distribute the threshold voltages of the memory cells into eight levels.

In an embodiment, a semiconductor device may include a memory block including a plurality of memory cells. The semiconductor device may also include an operation circuit configured to perform a first program loop, a second program loop, and a third program loop based on data stored in the memory cells. The first program loop may distribute threshold voltages of the memory cells into a first plurality of levels. The second program loop may distribute the threshold voltages of the memory cells into a second plurality of levels. The third program loop may distribute the threshold voltages of the memory cells into a third plurality of levels.

In an embodiment, a memory system comprises a memory controller including a central processing unit and configured to receive and send commands to a nonvolatile memory device. The nonvolatile memory device may include a memory block including a plurality of memory cells. The semiconductor device may also include an operation circuit configured to receive the commands and perform a first program loop, a second program loop, and a third program loop based on data stored in the memory cells. The first program loop may distribute threshold voltages of the memory cells into a first plurality of levels. The second program loop may distribute the threshold voltages of the memory cells into a second plurality of levels. The third program loop may distribute the threshold voltages of the memory cells into a third plurality of levels.

### BRIEF DESCRIPTION OF THE DRAWINGS

FIG. 1 is a block diagram illustrating a representation of a semiconductor device according to an example of an embodiment.

FIG. 2 is a circuit diagram illustrating a representation of a memory block illustrated in FIG. 1.

FIGS. 3A to 3D are graphs illustrating representations of voltage distributions in a method of operating a semiconductor device according to an example of an embodiment.

FIG. 4 is a block diagram illustrating a representation of a memory system according to an example of an embodiment.

FIG. 5 is a block diagram illustrating a representation of a fusion memory device or a representation of a fusion memory system performing a program operation according to an example of an embodiment.

FIG. 6 is a block diagram illustrating a representation of a computing system including a flash memory device according to an example of an embodiment.

### BRIEF DESCRIPTION OF THE DRAWINGS

The embodiments will be described more fully hereinafter with reference to the accompanying drawings, in which various examples of the embodiments are illustrated. These embodiments may, however, be embodied in different forms and should not be construed as limited to the embodiments set forth herein.

Various embodiments may be directed to a semiconductor device capable of decreasing a chip size and storing data efficiently.

According to the semiconductor device of various embodiments, a chip size may be decreased, and reliability and efficiency of storing data may be improved.

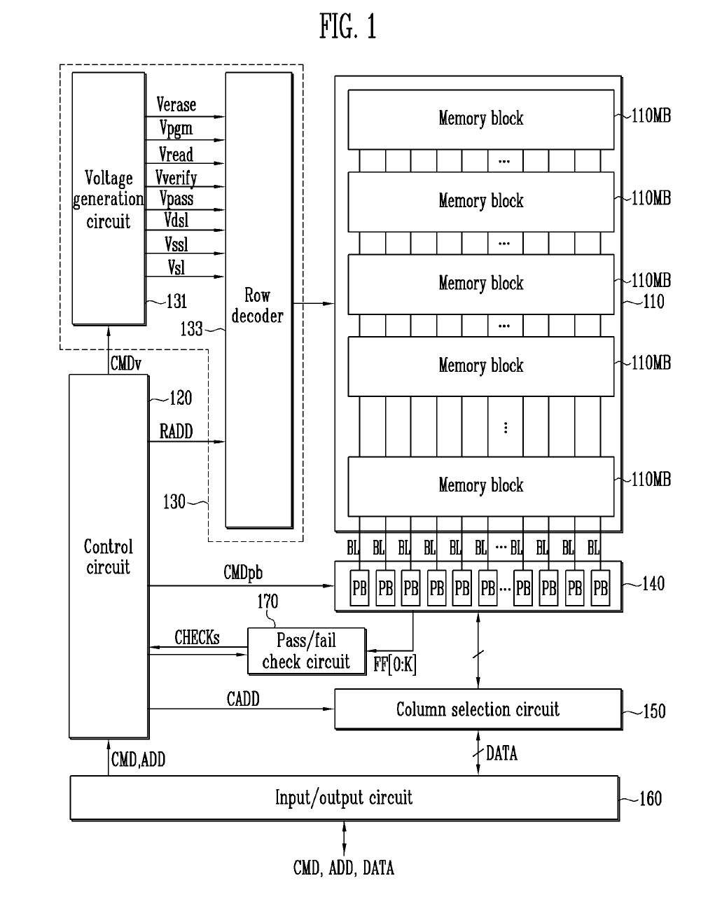

FIG. 1 is a block diagram illustrating a representation of a semiconductor device according to an example of an embodiment.

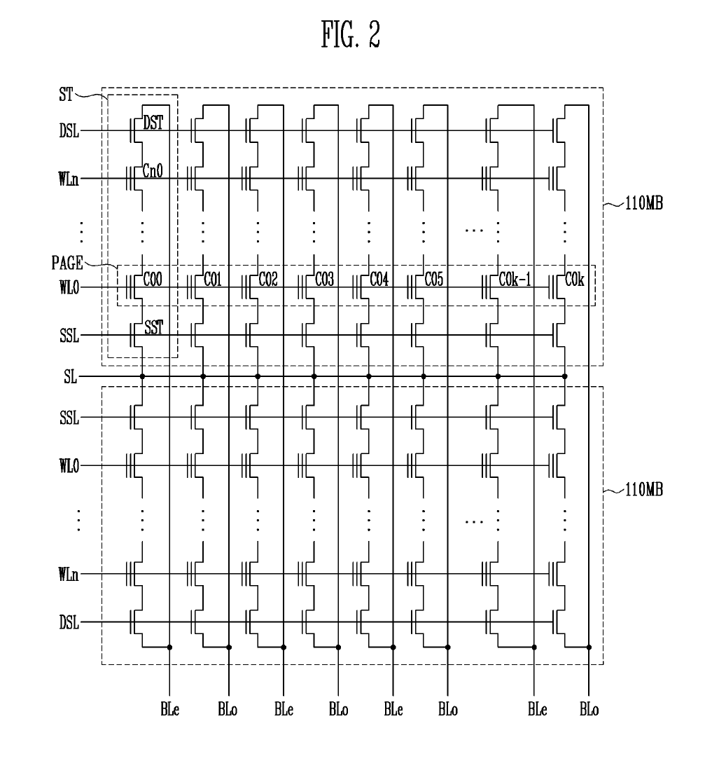

Referring to FIG. 1, the semiconductor device may include a memory array 110 and operation circuits 120 to 170. The memory array 110 may include a plurality of memory blocks 110MB. A structure of each of the memory blocks 110MB will be described below with reference to FIG. 2.

FIG. 2 is a representation of a circuit diagram illustrating a memory block illustrated in FIG. 1.

Referring to FIG. 2, each of the memory blocks may include a plurality of memory strings ST connected between a plurality of bit lines BLe and BLo and a common source line SL. Each of the memory strings ST may be connected to a corresponding bit line of the bit lines BLe and BLo. The memory strings ST may be commonly connected to the common source line SL. Each of the memory strings ST may include a source select transistor SST, a cell string, and a drain select transistor DST. The source select transistor SST may be connected to the common source line SL. A plurality of memory cells C00 to Cn0 may be connected in series to form the cell string. The drain select transistor DST may be connected to the bit line BLe. The memory cells C00 to Cn0 included in the cell string may be connected in series between the select transistors SST and DST. A gate of the source select transistor SST may be connected to a source select line SSL. Gates of the memory cells C00 to Cn0 may be connected to a plurality of word lines WL0 to WLn, respectively. A gate of the drain select transistor DST may be connected to a drain select line DSL.

The drain select transistor DST may control the connection or disconnection between the cell string and the bit line. The source select transistor SST may control the connection or disconnection between the cell string and the common source line SL.

For example, in a NAND flash memory device, memory cells in a memory cell block may be divided in a physical page unit or a logical page unit. For example, memory cells C00 to C0k connected to one word line (for example, WL0) constitute one physical page PAGE. Also, even numbered memory cells C00, C02, C04, and C0k-1 connected to one word line (for example, WL0) may constitute an even page, and odd numbered memory cells C01, C03, C05, and C0k may constitute an odd page. The page (or the even page and the odd page) may be a basic unit of a program operation or a read operation.

Referring again to FIGS. 1 and 2, the operation circuits 120 to 170 may be configured to perform a program loop, an erase loop, and a read operation of the memory cells C00 to C0k connected to a selected word line (for example, WL0). The program loop may include a program operation and a verify operation. The erase loop may include an erase operation and a verify operation.

The operation circuits 120 to 170 may perform the program loop with an Increment Step Pulse Program (ISPP) method. The operation circuits 120 to 170 may repeat the program operation and the verify operation until all of the threshold voltages of the memory cells C00 to C0k connected to the selected word line (for example, WL0) reach a reference level. The operation circuits 120 to 170 may repeat the program operation for storing data and the verify operation for verifying the stored data until input data that are from an outside are stored in the memory cells C00 to C0k of the selected word line (for example, WL0).

The operation circuits 120 to 170 may increase a program voltage Vpgm applied to the selected word line by a predetermined step voltage in every repeating program operation. When the program operation is performed, the operation circuits 120 to 170 may apply the program voltage Vpgm that has a greater voltage level than that of a program voltage of a previous program operation by the step voltage to the selected word line WL0.

In order to perform the program loop, the erase loop, and the read operation, the operation circuits 120 to 170 are configured to selectively output operation voltages Vease, Vpgm, Vread, Vverify, Vpass, Vdsl, Vssl, and Vsl to local lines SSL, WL0 to WLn, DSL of the selected memory block and the common source line SL, and to control precharge/discharge of the bit lines BLe and BLo, or to sense a current flow of the bit lines BLe and BLo. For example, an erase voltage Verase may be applied to a substrate or a bulk (not shown) on which the memory cells are formed during the erase operation. The program voltage Vpgm may be applied to the selected word line during the program operation. A read voltage Vread may be applied to the selected word line during the read operation. A verify voltage Vverify may be applied to the selected word line during the verify operation. A pass voltage Vpass may be applied from the selected word line to non-selected word lines during the program operation, the read operation, or the verify operation. A drain select voltage Vdsl may be applied to the drain select line DSL. A source select voltage Vssl may be applied to the source select line. A source voltage Vsl may be applied to the common source line SL.

For example, in the NAND flash memory device, the operation circuits may include a control circuit 120, a voltage supply circuit 130, and a read/write circuit group 140. The operation circuits of the NAND flash memory device may include a column selection circuit 150, an input/output circuit 160, and a pass/fail check circuit 170. The above-mentioned elements will be described below.

The control circuit 120 may output a voltage control signal CMDv in response to a command signal CMD received from outside the semiconductor device through the input/output circuit 160. The voltage control signal CMDv may be used to control the voltage supply circuit 130 to generate the operation voltages Verase, Vpgm, Vread, Vverify, Vpass, Vdsl, Vssl, and Vsl at desired levels. The operation voltages Verase, Vpgm, Vread, Vverify, Vpass, Vdsl, Vssl, and Vsl at the desired levels may be used to perform the program loop, the erase loop, and the read operation. The control circuit 120 may output control signals CMDpb. The control signals CMDpb may be used to control read/write circuits (or page buffers PB) of the read/write circuit group 140 to perform the program loop, the erase loop, and the read operation. The control circuit 120 may receive an address signal ADD to generate a column address signal CADD and a row address signal RADD and to output the column address signal CADD and the row address signal RADD.

In response to the voltage control signal CMDv received from the control circuit 120, the voltage supply circuit 130 may generate the operation voltages Verase, Vpgm, Vread, Vverify, Vpass, Vdsl, Vssl, and Vsl for the program loop, the erase loop, and the read operation of the memory cells. In response to the row address signal RADD received from the control circuit 120, the voltage supply circuit 130 may output the operation voltages to the local lines SSL, WL0 to WLn, DSL of the selected memory block and the common source line SL.

The voltage supply circuit 130 may include a voltage generation circuit 131 and a row decoder 133. In response to the voltage control signal CMDv received from the control circuit 120, the voltage generation circuit 131 may generate the operation voltages Verase, Vpgm, Vread, Vverify, Vpass, Vdsl, Vssl, and Vsl. In response to the row address signal RADD received from the control circuit 120, the row decoder 133 may apply the operation voltages to the local lines SSL, WL0 to WLn, DSL of the selected memory block of the memory blocks 110MB and the common source line SL.

Hereinafter, the verify voltage Vverify output from the voltage supply circuit 130 may include verify voltages V1_1 to V1_3, V2_1 to V2_6, V3_1 to V3_7, V1 to V7.

The read/write circuit group 140 may include a plurality of read/write circuits (for example, page buffers) PB connected to the memory array 110 through the bit lines BLe and BLo. Each of the read/write circuits PB may be connected to each of the bit lines BLe and BLo. For example, one read/write circuit PB may be connected to one bit line. Each of the read/write circuits PB may be connected to each pair of bit lines BLe and BLo.

In the program operation, the read/write circuits PB may selectively precharge the bit lines BLe and BLo based on a PB control signal CMDpb of the control circuit 120 and the data DATA to be stored in the memory cells. In the verify operation or the read operation, the read/write circuits PB may precharge the bit lines BLe and BLo and then sense the voltage variation or current of the bit lines BLe and BLo to latch the data read from the memory cells, based on the PB control signal CMDpb of the control circuit 120.

The read/write circuits PB may output pass/fail signals FF[0:k] to the pass/fail check circuit 170. The pass/fail signals FF[0:k] may be used to check whether a program passed/failed or to check whether an erase passed/failed in the memory cells based on the data read from the memory cells during the verify operation (or based on the threshold voltages of the memory cells that are checked during the verify operation). In order to perform the above-mentioned operation, the read/write circuits PB may include a plurality of latch circuits configured to temporarily store the data to be stored in the memory cells and to store verify results of the memory cells.

In response to the column address CADD received from the control circuit 120, the column selection circuit 150 may select the read/write circuits PB of the read/write circuit group 140. In response to the column address CADD, the column selection circuit 150 may sequentially transmit the data to be stored in the memory cells to the read/write circuits PB. In order to output the data of the memory cells to an outside (i.e., outside the semiconductor device), which are latched to the read/write circuits PB by the read operation, the column selection circuit 150 may sequentially select the read/write circuits PB in response to the column address CADD.

The input/output circuit 160 may transmit the command signal CMD and the address signal ADD that are received from outside the semiconductor device to the control circuit 120. The input/output circuit 160 may transmit the data DATA received from outside the semiconductor device to the column selection circuit 150 in the program operation. In a read operation, the input/output circuit 160 may read from the memory cells and output the data outside the semiconductor device.

The pass/fail check circuit 170 may be configured to perform the verify operation. The verify operation may be used for determining the pass/fail of the program, and then to sense an amount of the current changed based on the check signals FF[0:k] output from the read/write circuits PB. The pass/fail check circuit 170 may output a check result signal CHECKs to the control circuit 120 based on the check signals FF[0:k].

The control circuit 120 may determine the repeating of the program operation in response to the check result signal CHECKs.

The operation circuits 120 to 170 may perform a first program loop for distributing the threshold voltages of the memory cells into four levels, based on the data stored in the memory cells. The operation circuits 120 to 170 may perform a second program loop for distributing the threshold voltages of the memory cells into seven levels, based on the data stored in the memory cells. The operation circuits 120 to 170 may perform a third program loop for distributing the threshold voltages of the memory cells into eight levels, based on the data stored in the memory cells. Also, after the third program loop is completed, the operation circuits 120 to 170 may further perform an additional program loop for increasing an interval of the threshold voltage distributions of the memory cells.

Hereinafter, a method of operating the semiconductor device will be explained.

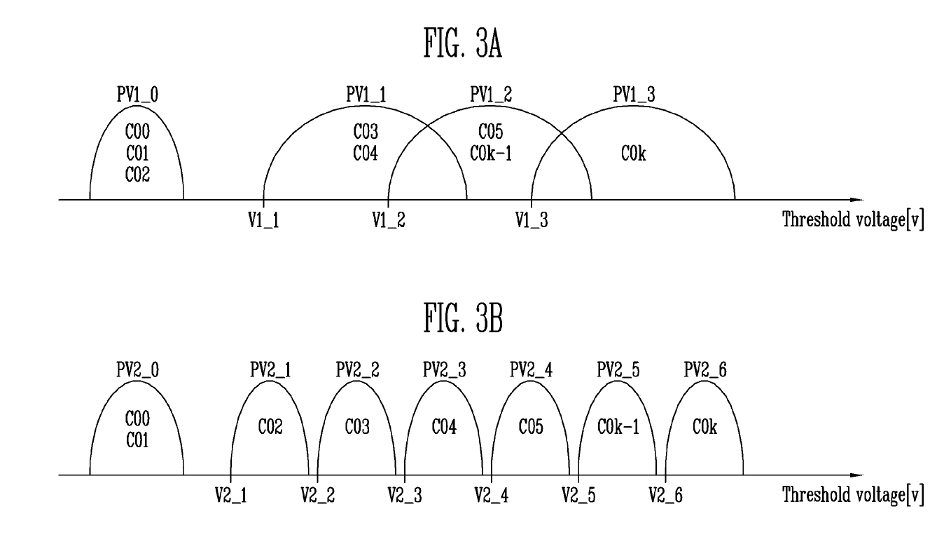

FIGS. 3A to 3D are graphs illustrating representations of voltage distributions in a method of operating a semiconductor device according to an example of an embodiment.

Referring to FIGS. 1, 2, and 3A, the operation circuits 120 to 170 may perform the program loop for storing the data in the memory cells C00 to C0k connected to the selected word line (for example, WL0). For example, data having the erase level are stored in a first memory cell C00 of the three bit data (for example, 000, 001, 010, 011, 100, 101, 110, 111). Data having the first program level is stored in the second memory cell C01. Data having the second program level is stored in the third memory cell C02. Data having the third program level is stored in the fourth memory cell C03. Data having a fourth program level is stored in the fifth memory cell C04. Data having a fifth program level is stored in the sixth memory cell C05. Data having a sixth program level is stored in the seventh memory cell C0k-1. Data having a seventh program level is stored in the eighth memory cell C0k.

The operation circuits 120 to 170 may perform the program loop, by determining a verify voltage and a step voltage based on, for example but not limited to, the following Table 1.

TABLE 1

| Program | | | | additional |
|---|---|---|---|---|
| loop | 1^{st} PGM loop | 2^{nd} PGM loop | 3^{rd} PGM loop | PGM loop |
| Vstep | 650 mV~750 mV | 450 mV~550 mV | 150 mV~250 mV | 500 mV~600 mV |
| Memory | No. of Vth distribution | | | |
| cell | 4 | 7 | 8 | 8 |
| C00 | PV1_0 | PV2_0 | PV3_0 | PVO |
| | (Erase state) | (Erase state) | (Erase state) | (Erase state) |
| C01 | | | PV3_1 | PV1 |
| | | | (V3_1 = 0 V) | (V1 = 0.9 V~1.1 V) |
| C02 | | PV2_1 | PV3_2 | PV2 |
| | | (V2_1 = 0.2 V~0.4 V) | (V3_2 = 0.7 V~0.9 V) | (V2 = 1.57 V~1.77 V) |
| C03 | PV1_1 | PV2_2 | PV3_3 | PV3 |
| | (V1_1= 0.4 V~0.6 V) | (V2_2 = 0.95 V~1.15 V) | (V3_3 = 1.4 V~1.6 V) | (V3 = 2.24 V~2.44 V) |
| C04 | | PV2_3 | PV3_4 | PV4 |
| | | (V2_3 = 1.7 V~1.9 V) | (V3_4 = 2.1 V~2.3 V) | (V4 = 2.91 V~3.11 V) |
| C05 | PV1_2 | PV2_4 | PV3_5 | PV5 |
| | (V1_2=1.4 V~1.6 V) | (V2_4 = 2.4 V~2.6 V) | (V3_5 = 2.8 V~3.0 V) | (V5 = 3.58 V~3.78 V) |
| C0k-1 | | PV2 _5 | PV3_6 | PV6 |
| | | (V2_5 = 3.35 V~3.45 V) | (V3_6 = 3.4 V~3.6 V) | (V6 = 4.25 V~4.45 V) |
| C0k | PV1_3 | PV2_6 | PV3_7 | PV7 |
| | (V1_3 = 2.4 V~2.6 V) | (V2_6 = 3.85 V~4.05 V) | (V3_7 = 4.1 V~4.3 V) | (V7 = 4.92 V~5.12 V) |

The operation circuits 120 to 170 may perform the first program loop for distributing the threshold voltages of the memory cells C00 to C0k into the four levels PV1_0, PV1_1, PV1_2, and PV1_3 based on the data stored in the memory cells C00 to C0k.

For example, the operation circuits may perform the first program loop so that the threshold voltages of the memory cells C00, C01, and C02 for storing the data having the erase level and the data having the first and second program levels are distributed in the erase level PV1_0. The operation circuits may perform the first program loop so that the threshold voltages of the memory cells C03 and C04 for storing the data of the third and fourth program levels, the threshold voltages of the memory cells C05 and C0k-1 for storing the data of the fifth and sixth program levels, and the threshold voltage of the memory cell C0k for storing the data of the seventh program level are distributed into the three program levels PV1_1, PV1_2, and PV1_3.

The first program loop may include a first program operation and a first verify operation. In order to perform the first program operation, the operation circuits 120 to 170 may apply the program voltage Vpgm to the selected word line (for example, WL0), may apply the pass voltage Vpass to the non-selected word lines (for example, WL1 to WLn), may apply a program intolerant voltage (for example, a power supply voltage) to the bit lines BLe and BLo of the first to third memory cells C00 to C02, and may apply a program tolerant voltage (for example, a ground voltage) to the bit lines BLe and BLo of the fourth to seventh memory cells C03 to C0k. As a result, the threshold voltages of the fourth to seventh memory cells C03 to C0k may be increased.

Then, the operation circuits 120 to 170 may perform the first verify operation. In the first verify operation, in order to check the threshold voltages of the fourth and fifth memory cells C03 and C04 to reach at a target level PV1_1, the operation circuits 120 to 170 may apply the verify voltage V1_1 to the selected word line WL0 while the bit lines BLe and BLo of the fourth and fifth memory cells C03 and C04 are precharged. The verify voltage V1_1 may be, for example but not limited to, about 0.4 V to 0.6 V. Then, the operation circuits 120 to 170 may sense voltage variations of the bit lines BLe and BLo of the fourth and fifth memory cells C03 and C04 to latch the sensed result.

In order to check the threshold voltages of the sixth and seventh memory cells C05 and C06 to reach at a target level PV1_2, the operation circuits 120 to 170 may apply the verify voltage V1_2 to the selected word line WL0 while the bit lines BLe and BLo of the sixth and seventh memory cells C05 and C06 are precharged. The verify voltage V1_2 may be, for example but not limited to, about 1.4 V to 1.6 V. Then, the operation circuits 120 to 170 may sense voltage variations of the bit lines BLe and BLo of the sixth and seventh memory cells C05 and C0k-1 to latch the sensed result.

In order to check the threshold voltage of the eighth memory cell C0k to reach at a target level PV1_3, the operation circuits 120 to 170 may apply the verify voltage V1_3 to the selected word line WL0 while the bit line BLo of the eighth memory cell C0k is precharged. The verify voltage V1_3 may be, for example but not limited to, about 2.4 V to 2.6 V. Then, the operation circuits 120 to 170 may sense a voltage variation of the bit line BLo of the eighth memory cell C0k to latch the sensed result.

The read/write circuit group 140 may output the check signals FF[0:k] based on the latched result that are formed by latching the sensed result, and the pass/fail check circuit 170 may output the check result signal CHECKs to the control circuit 120 based on the check signals FF[0:k]. The control circuit 120 may determine the repeating of the first program operation in response to the check result signal CHECKs. For example, when memory cells having threshold voltages that are not distributed at the target level are detected, the control circuit 120 controls the voltage supply circuit 130 and the read/write circuit group 140 to repeat the first program operation. The program voltage Vpgm may be increased by a step voltage Vstep of, for example but not limited to, about 650 mV to 750 mV. When the threshold voltages of the memory cells C03 to C0k are distributed at the target levels PV1_1, PV1_2, and PV1_3, respectively, the first program loop is completed.

Referring to FIGS. 1, 2, and 3B, the operation circuits 120 to 170 may perform the second program loop for distributing the threshold voltages of the memory cells C00 to C0k into the seven levels PV2_0 to PV2_6 based on the data stored in the memory cells C00 to C0k.

For example, the operation circuits 120 to 170 perform the second program loop so that the threshold voltages of the memory cells C00 and C01 for storing the data of the erase level and the data of the first program level are distributed at the erase level PV2_0. The operation circuits 120 to 170 may perform the second program loop so that the threshold voltage of the memory cell C02 for storing the data of the second program level, the threshold voltage of the memory cell C03 for storing the data of the third program level, the threshold voltage of the memory cell C04 for storing the data of the fourth program level, the threshold voltage of the memory cell C05 for storing the data of the fifth program level, the threshold voltage of the memory cell C0k-1 for storing the data of the sixth program level, and the threshold voltage of the memory cell C0k for storing the data of the seventh program level are distributed into the six program levels PV2_1 to PV2_6, respectively.

The second program loop may include a second program operation and a second verify operation. The second program loop may be performed in substantially the same method as the first program loop illustrated in FIG. 3A. However, the verify voltage V2_1 for the third memory cell C02 may be, for example but not limited to, about 0.2 V to 0.4 V, the verify voltage V2_2 for the fourth memory cell C03 may be, for example but not limited to, about 0.95 V to 1.15 V, the verify voltage V2_3 for the fifth memory cell C04 may be, for example but not limited to, about 1.7 V to 1.9 V, the verify voltage V2_4 for the sixth memory cell C05 may be, for example but not limited to, about 2.4 V to 2.6 V, the verify voltage V2_5 for the seventh memory cell C0k-1 may be, for example but not limited to, about 3.35 V to 3.45 V, and the verify voltage V2_6 for the eighth memory cell C0k may be, for example but not limited to, about 3.85 V to 4.05 V. Also, when the second program operation is repeated, the program voltage Vpgm may be increased by a step voltage Vstep of, for example but not limited to, about 450 mV to 550 mV.

When the threshold voltages of the memory cells C02 to C0k are distributed at the target levels PV2_1 to PV2_6, respectively, the second program loop is completed.

Referring to FIGS. 1, 2, and 3C, the operation circuits 120 to 170 may perform the third program loop for distributing the threshold voltages of the memory cells C00 to C0k into the eight levels PV3_0 to PV3_7 based on the data stored in the memory cells C00 to C0k.

For example, the operation circuits 120 to 170 may perform the third program loop so that the threshold voltage of the memory cell C00 for storing the data of the erase level is distributed at the erase level PV3_0. The operation circuits 120 to 170 may perform the third program loop so that the threshold voltage of the memory cell C01 for storing the data of the first program level, the threshold voltage of the memory cell C02 for storing the data of the second program level, the threshold voltage of the memory cell C03 for storing the data of the third program level, the threshold voltage of the memory cell C04 for storing the data of the fourth program level, the threshold voltage of the memory cell C05 for storing the data of the fifth program level, the threshold voltage of the memory cell C0k-1 for storing the data of the sixth program level, and the threshold voltage of the memory cell C0k for storing the data of the seventh program level may be distributed into the seven program levels PV3_1 to PV3_7, respectively.

The third program loop may include a third program operation and a third verify operation. The third program loop may be performed in substantially the same method as the first program loop illustrated in FIG. 3A. However, the verify voltage V3_1 for the second memory cell C01 may be, for example but not limited to, about 0 V, the verify voltage V3_2 for the third memory cells C02 may be, for example but not limited to, about 0.7 V to 0.9 V, the verify voltage V3_3 for the fourth memory cell C03 may be, for example but not limited to, about 1.4 V to 1.6 V, the verify voltage V3_4 for the fifth memory cell C04 may be, for example but not limited to, about 2.1 V to 2.3 V, the verify voltage V3_5 for the sixth memory cell C05 may be, for example but not limited to, about 2.8 V to 3.0 V, the verify voltage V3_6 for the seventh memory cell C0k-1 may be, for example but not limited to, about 3.4 V to 3.6 V, and the verify voltage V3_7 for the eighth memory cell C0k may be, for example but not limited to, about 4.1 V to 4.3 V. Also, when the third program operation is repeated, the program voltage Vpgm may be increased by a step voltage Vstep of, for example but not limited to, about 150 mV to 250 mV.

When the threshold voltages of the memory cells C01 to C0k are distributed at the target levels PV3_1 to PV3_7, respectively, the third program loop is completed.

Referring to the operation conditions of Table 1, the operation circuits 120 to 170 may be configured to have different increasing steps Vstep from the program voltage Vpgm of the first program loop, the program voltage Vpgm of the second program loop, and the program voltage Vpgm of the third program loop. For example, the operation circuits may have a maximum increasing step at the program voltage Vpgm of the first program loop, and have a minimum increasing step at the program voltage Vpgm of the third program loop.

When the step voltages Vstep of the program voltages Vpgm of the first to third program loops and the verify voltages of the first to third program loops are changed, a width of the threshold voltage distribution may be gradually decreased and an interval of the threshold voltage distribution may be gradually increased. In particular, when the step voltage Vstep of the program voltage Vpgm is decreased, the width and interval of the threshold voltage distribution may be precisely controlled in the third program loop. In the first and second program loops, the program voltage Vpgm and the step voltage Vstep are high, so that the speed of the program loop may be increased.

Referring to FIGS. 1, 2, and 3D, after the third program loop is completed, the operation circuits 120 to 170 may further perform an additional program loop to increase the interval of the threshold voltage distribution of the memory cells C00 to C0k and to decrease the width of the threshold voltage distribution of the memory cells C00 to C0k.

The additional program loop may include an additional program operation and an additional verify operation. The additional program loop may be performed in substantially the same method as the third program loop illustrated in FIG. 3C. However, the verify voltage V1 for the second memory cell C01 may be, for example but not limited to, about 0.9 V to 1.1 V, the verify voltage V2 for the third memory cells C02 may be, for example but not limited to, about 1.57 V to 1.77 V, the verify voltage V3 for the fourth memory cell C03 may be, for example but not limited to, about 2.24 V to 2.44 V, the verify voltage V4 for the fifth memory cell C04 may be, for example but not limited to, about 2.91 V to 3.11 V, the verify voltage V5 for the sixth memory cell C05 may be, for example but not limited to, about 3.58 V to 3.78 V, the verify voltage V6 for the seventh memory cell C0k-1 may be, for example but not limited to, about 4.25 V to 4.45V, and the verify voltage V7 for the eighth memory cell C0k may be, for example but not limited to, about 4.92 V to 5.12 V. Also, when the additional program operation is repeated, the program voltage Vpgm may be increased by a step voltage Vstep of, for example but not limited to, about 500 mV to 600 mV.

The operation circuits 120 to 170 may set the program voltage of the additional program loop to have a greater increasing step than that of the program voltage of the third program loop. Also, the operation circuits 120 to 170 may set the program voltage of the additional program loop to have a smaller increasing step than that of the program voltage of the first program loop or the program voltage of the second program loop.

Thus, the threshold voltages of all of the memory cells C00 to C0k may be distributed in the target levels PV0 to PV7, and the three bit data is stored in each of the memory cells C00 to C0k.

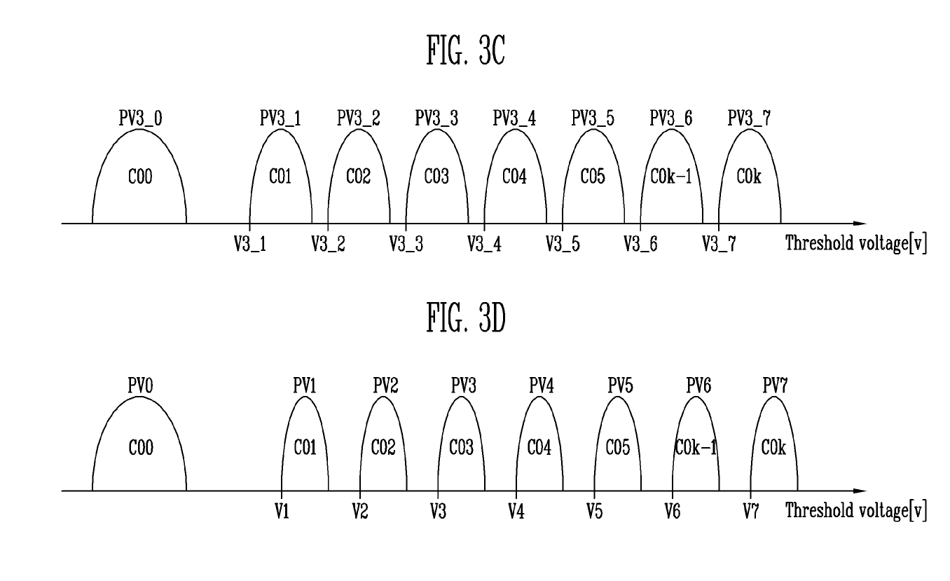

FIG. 4 is a block diagram illustrating a representation of a memory system according to an example of an embodiment.

Referring to FIG. 4, the memory system 400 may include a nonvolatile memory device 420 and a memory controller 410.

The nonvolatile memory device 420 may include the semiconductor device illustrated in FIG. 1. Also, the nonvolatile memory device 420 may store data using the method illustrated in FIGS. 3A to 3D. The memory controller 410 may be configured to control the nonvolatile memory device 420. The nonvolatile memory device 420 may be combined with the memory controller 410 to be used for a memory card or a Solid State Disk (SSD). An SRAM 411 may be used for an operation memory of a Central Processing Unit (CPU) 412. A host interface 413 may include a data exchange protocol of a host connected with the memory system 400. An Error Correction Code (ECC) 414 detects and corrects an error in the data read from a cell region of the nonvolatile memory device 420. A memory interface 415 interfaces with the nonvolatile memory device 420. The CPU 412 performs control operations for exchanging data with the memory controller 410.

Although not illustrated in FIG. 4, the memory system 400 may further include a ROM (not shown) that stores code data for interfacing with the host, etc. Those of ordinary skill in the art may understand that the memory system 400 may have various structures. The nonvolatile memory device 420 may be provided as a multi-chip package including a plurality of flash memory chips. The memory system 400 may be used for highly reliable storage media having improved operation characteristics. In particular, the solid state disk (SSD) that has been actively studied may include the flash memory device of the present example of the embodiment. In these examples, the memory controller 410 may communicate with an outside (for example, the host) through one of various interface protocols such as USB, MMC, PCI-E, SATA, PATA, SCSI, ESDI, IDE, etc.

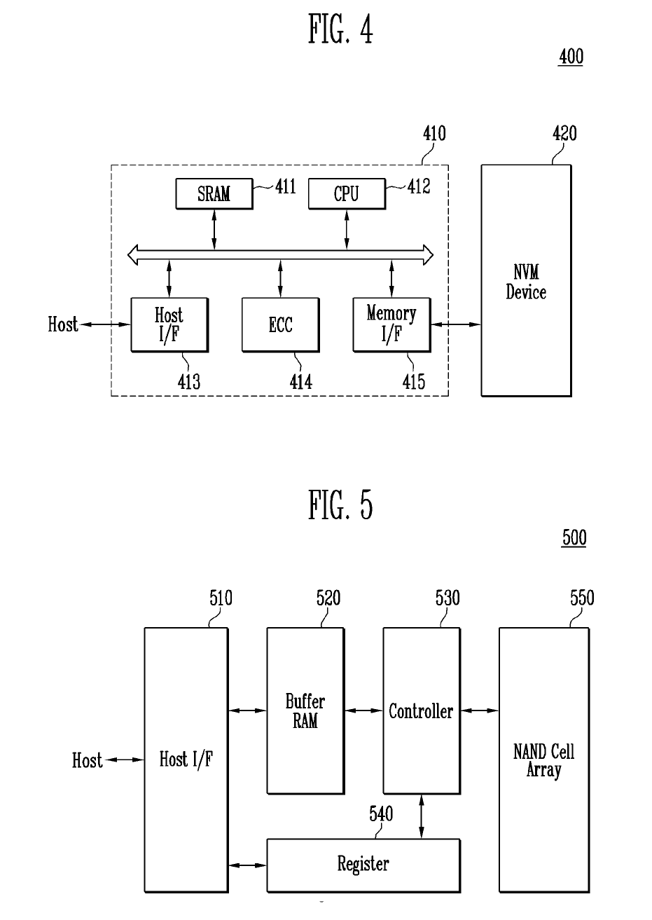

FIG. 5 is a block diagram illustrating a representation of a fusion memory device or a representation of a fusion memory system performing a program operation according to an example of an embodiment. For example, the fusion memory device may include, for example but not limited to, an OneNAND flash memory device 500.

The OneNAND flash memory device 500 may include a host interface 510, a buffer RAM 520, a controller 530, a register 540, and a NAND flash cell array 550. The host interface 510 may be configured to exchange information with devices that use different protocols. The buffer RAM 520 may include a code for driving the memory device, or temporarily stores data. The controller 530 controls reading, programming, and other operations in response to a control signal and a command that are provided from an outside. The register 540 stores data such as the command, an address, a configuration for defining a system operation environment inside the memory device, etc. The NAND flash cell array 550 may include operation circuits having a nonvolatile memory cell and a page buffer. The OneNAND flash memory device programs the data based on a general method in response to a write request of the host.

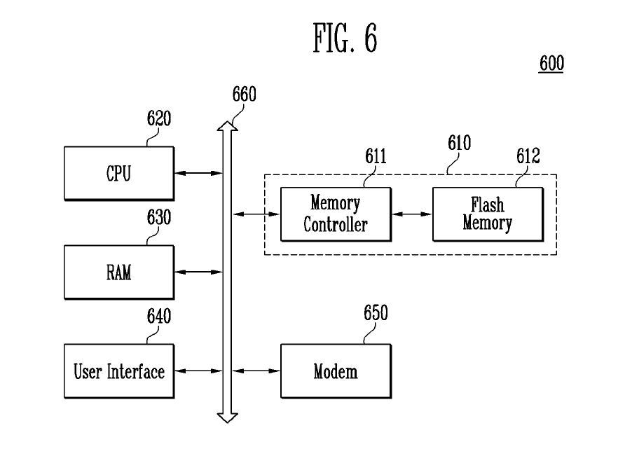

FIG. 6 is a block diagram illustrating a representation of a computing system including a flash memory device according to an example of an embodiment.

The computing system 600 may include a central processing unit (CPU) 620, a RAM 630, a user interface 640, a modem 650, and a memory system 610, each of which is connected to a system bus 660. The modem 650 may include a baseband chipset. When the computing system 600 is a mobile apparatus, the computing system 600 may further include a battery (not shown) configured to supply a power. Although not illustrated in FIG. 6, those of ordinary skill in the art may understand that the computing system 600 may further include an application chipset, a camera image processor (CIS), a mobile DRAM, etc. The memory system 610, for example, may be configured with a Solid State Drive/disk (SSD) using the nonvolatile memory illustrated in FIG. 1 in order to store data. Alternatively, the memory system 610 may be provided as a fusion flash memory (for example, a OneNAND flash memory).

In the drawings and specification, there have been disclosed various examples of embodiments of the invention and, although specific terms are employed, they are used in a generic and descriptive sense only and not for purposes of limitation. As for the scope of the embodiments, it is to be set forth in the following claims. Therefore, it will be understood by those of ordinary skill in the art that various changes in form and details may be made therein without departing from the spirit and scope of the embodiments as defined by the following claims.

What is claimed is:

1. A semiconductor device comprising:
a memory block including a plurality of memory cells; and
an operation circuit configured to perform a first program loop, a second program loop, and a third program loop based on data stored in the memory cells,
wherein the first program loop distributes threshold voltages of the memory cells into four levels,
wherein the second program loop distributes the threshold voltages of the memory cells into seven levels, and
wherein the third program loop distributes the threshold voltages of the memory cells into eight levels.

2. The semiconductor device of claim 1, wherein the operation circuit is configured to set a first increasing step of a program voltage of the first program loop, a second increasing step of the program voltage of the second program loop, and a third increasing step of the program voltage of the third program loop,
wherein the first increasing step is different from the second increasing step, and the second increasing step is different from the third increasing step.

3. The semiconductor device of claim 2, wherein the operation circuit is configured to set the first increasing step to have the greatest increasing step and the third increasing step to have the least increasing step.

4. The semiconductor device of claim 1, wherein the operation circuit performs the first program loop so that threshold voltages of memory cells in an erase state are distributed into an erase level and three program levels, respectively.

5. The semiconductor device of claim 4, wherein the operation circuit performs the first program loop so that threshold voltages of memory cells for storing data of the erase level and data of first and second program levels are distributed into the erase level.

6. The semiconductor device of claim 4, wherein the operation circuit performs the first program loop so that threshold voltages of memory cells for storing data of third and fourth program levels, threshold voltages of memory cells for storing data of fifth and sixth program levels, and a threshold voltage of a memory cell for storing data of a seventh program level are distributed into the three program levels.

7. The semiconductor device of claim 1, wherein the operation circuit performs the second program loop so that the threshold voltages of the memory cells after completion of the first program loop are distributed into an erase level and six program levels, respectively.

8. The semiconductor device of claim 7, wherein the operation circuit performs the second program so that a threshold voltage of a memory cell for storing data of the erase level and data of a first program level is distributed into the erase level.

9. The semiconductor device of claim 7, wherein the operation circuit performs the second program loop so that threshold voltages of memory cells for storing data of second to seventh program levels are distributed into the six program levels, respectively.

10. The semiconductor device of claim 1, wherein the operation circuit performs the third program loop so that the threshold voltages of the memory cells after completion of the second program loop are distributed into an erase level and seven program levels, respectively.

11. The semiconductor device of claim 10, wherein the operation circuit performs the third program loop so that a threshold voltage of a memory cell for storing data of the erase level is distributed into the erase level and threshold voltages of memory cells for storing data of first to seventh program levels are distributed into the seven program levels, respectively.

12. The semiconductor device of claim 1, wherein after completion of the third program loop, the operation circuit is configured further to perform an additional program loop for increasing an interval of threshold voltage distributions of the memory cells.

13. The semiconductor device of claim 12, wherein the operation circuit sets a program voltage in the additional program loop to have a greater increasing step than that of the program voltage of the third program loop.

14. The semiconductor device of claim 12, wherein the operation circuit sets a program voltage of the additional program loop to have a smaller increasing step than that of the program voltage of the first program loop or the second program loop.

15. A memory system comprising:
a memory controller including a central processing unit and configured to receive and send commands to a nonvolatile memory device, the nonvolatile memory device including:
a memory block including a plurality of memory cells; and
an operation circuit configured to receive the commands and perform a first program loop, a second program loop, and a third program loop based on data stored in the memory cells,
wherein the first program loop distributes threshold voltages of the memory cells into four levels,
wherein the second program loop distributes the threshold voltages of the memory cells into seven levels, and
wherein the third program loop distributes the threshold voltages of the memory cells into eight levels.
